(19) United States
(12) Patent Application Publication
(10) Pub. No.: US 2025/0300833 A1
(43) Pub. Date: Sep. 25, 2025

(54) SURROGATE AUTHENTICATION AND DATA SHARING

(71) Applicant: Valid Dot Care, Inc., Aurora, NE (US)

(72) Inventor: Jonathan G. Rhoades, Aurora, NE (US)

(73) Assignee: Valid Dot Care, Inc., Aurora, NE (US)

(21) Appl. No.: 19/084,409

(22) Filed: Mar. 19, 2025

Related U.S. Application Data
(60) Provisional application No. 63/569,113, filed on Mar. 23, 2024.

(51) Int. Cl. H04L 9/32; G06F 21/62

(52) U.S. Cl. CPC H04L 9/3213; G06F 21/6245

(57) ABSTRACT

A system for adding a surrogate as a digital proxy to data associated with a user and sharing the data by the surrogate, comprises an authentication server and an encrypted datastore. The authentication server is accessed by the surrogate using a single-use temporary link which was generated at the request of a user. The authentication server identifies the surrogate and confirms willingness of the surrogate to act as a digital proxy for the user. In response to the surrogate accessing the authentication server, being authenticated by the authentication server, and providing a valid data claim from a third-party application the authentication server generates a single-use datastore token which is used to access user data associated with the data claim and stored in an encrypted fashion within the encrypted datastore. After decryption, the decrypted user data is forwarded by the encrypted datastore to a third-party application.

### CROSS-REFERENCE TO RELATED APPLICATIONS

This application claims priority to and benefit of co-pending U.S. Provisional Patent Application No. 63/569,113 filed on Mar. 23, 2024, entitled “SURROGATE AUTHENTICATION AND DATA SHARING” by Jonathan G. Rhoades, having Attorney Docket No. VALID-001-PR, and assigned to the assignee of the present application, the disclosure of which is hereby incorporated herein by reference in its entirety.

### BACKGROUND

The healthcare industry's ever-increasing dependency on digital data underscores critical challenges in managing personal health information (PHI) and non-clinical patient data securely and effectively. PHI for a person may comprise one or more personal healthcare records (PHR) and/or electronic healthcare records (EHR) for the person. While advancements such as EHRs have substantially improved data accessibility, the level of control patients and their authorized representatives hold over their PHI and non-clinical data is still quite limited, and these limitations persist despite growing demands from patients for enhanced autonomy over their data.

### BRIEF DESCRIPTION OF THE DRAWINGS

The accompanying drawings, which are incorporated in and form a part of the Detailed Description, illustrate various embodiments of the subject matter and, together with the Detailed Description, serve to explain principles of the subject matter discussed below. Unless specifically noted, the drawings referred to in this Brief Description of the Drawings should be understood as not being drawn to scale. Herein, like items are labeled with like item numbers.

FIG. 1A illustrates an example system for surrogate authentication and data sharing, in accordance with various embodiments.

FIG. 1B demonstrates the architecture and workflow of authentication and updating or requesting user data through a data claim, user credentials, a session token, and a single-use datastore token within the system of FIG. 1A, in accordance with various embodiments.

FIG. 1C represents the architecture and workflow of reverifying a session token by the healthcare application within the system of FIG. 1A, in accordance with various embodiments.

FIG. 1D represents the architecture and workflow of updating or requesting user data through a data claim with an existing session token within the system of FIG. 1A, in accordance with various embodiments.

FIG. 2 illustrates a flow diagram of an example method, which uses one or more components of the system of FIG. 1A, of surrogate authentication and data sharing and of adding a surrogate with access to personal data associated with a user, according to various embodiments.

FIG. 3 is a flow diagram of an example method, which uses one or more components of the system of FIG. 1A, of surrogate authentication and data sharing, of enabling users or a surrogate to share user data.

FIG. 4 illustrates a flow diagram of a method, which uses one or more components of the system of FIG. 1A, of surrogate authentication and data sharing, according to various embodiments.

FIG. 5 illustrates one example of a type of computer that can be used in accordance with or to implement various embodiments which are discussed herein.

FIGS. 6A-6D illustrate a flow diagram of procedures in an example method of adding a surrogate as a digital proxy to data associated with a user and sharing the data by the surrogate, in accordance with various embodiments.

### DETAILED DESCRIPTION

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

### Overview of Discussion

The advent of digital healthcare platforms has accentuated the need for sophisticated data security mechanisms that empower not just patients but also their authorized proxies, such as parents or guardians, to control access to PHI and non-clinical data. This control is pivotal in addressing privacy concerns, building patient trust in digital healthcare systems, and fostering transparent and trustworthy relationships between healthcare providers and patients. Easy access and sharable, surrogate access to PHI, non-clinical data, and other types of sensitive personal data have been long felt but unresolved needs, that the systems and techniques describe herein provide.

A system for surrogate authentication and data sharing, as described herein, introduces granular permission for both PHI and non-clinical user data, significantly enhancing security and patient autonomy in healthcare data management. The system facilitates a user adding a surrogate (human) as a digital proxy to data associated with the user and further facilitates the sharing of the data by the surrogate. The system allows for Single Sign-On (SSO), in some embodiments, which simplifies the authentication process across healthcare platforms, ensures stringent verification at every data request, allows for authorized surrogate authentication, and decouples the authentication server from the encrypted datastore for greater autonomy.

The necessity for efficient data interoperability and seamless integration across diverse healthcare platforms has positioned Single Sign-On (SSO) as a useful technological feature, offering user convenience and bolstered security by minimizing the risks associated with multiple login credentials. Moreover, the introduction of secure data-sharing principles and the surrogate authentication mechanism enhances the verification process, ensuring robust protection of either or both of PHI of the user and non-clinical user data which is sensitive in some manner to the user.

Sharing PHI, non-clinical data, and/or other personal or sensitive information at time of authentication, facilitated by a blockchain, storage, and database agnostic encrypted datastore, is useful for achieving interoperability of healthcare data systems. This method not only ensures secure data transmission and storage but also adheres to stringent authentication protocols. The flexibility provided by encrypted datastores promotes adaptability across various technological platforms, catering to the dynamic nature of healthcare data management. In the system and techniques described herein, blockchain may be used to create an immutable log of authentication events and data access transactions. Specifically, in some embodiments, each authentication event-such as the issuance of a session token or a single-use datastore token—is recorded as a hashed transaction on a blockchain. Such use of a blockchain for recording these authentication events and ensures verifiability and non-repudiation, meaning any access or authentication attempt can be audited later without the risk of alteration. For example, when an authentication server issues a single-use datastore token (SUDT) to grant temporary access to encrypted healthcare records, the event is recorded on a blockchain. This record includes details such as: 1) the identity of the requesting application (e.g., a healthcare provider); 2) a hashed reference to the encrypted record being accessed; and 3) a timestamp and cryptographic proof of issuance. It is appreciated, that in various embodiments, less, more or different information may be included in such a blockchain recorded record. This mechanism for issuing and recording information about the issuance of SUDTs in a blockchain prevents unauthorized access while providing an auditable trail for compliance and security purposes.

The system and techniques described herein are intended to be blockchain-agnostic, meaning they can work with either a private permissioned blockchain (e.g., Hyperledger Fabric for enterprise settings, as but one example) or a public blockchain (e.g., Ethereum for transparency-focused implementations, as but one example).

Discussion begins with a description of some notation and nomenclature and then continues with description of an example system for authentication and data sharing, in accordance with various embodiments. Various depictions of the operation of the system are presented to demonstrate example operations which may be carried out by one or more components of the system. Flow diagrams are then presented to depict various methods for surrogate authentication and data sharing, for adding a surrogate for a user's data, for authenticating a user so that they me added as a surrogate, setting access and/or permissions of a surrogate, and passing a private key for secure access and of sharing of a user's information which is in an encrypted datastore. An example of a computer system and components thereof, with or upon which various methods described herein may be implemented, is depicted and described. A flow diagram of procedures of an example method of adding a surrogate as a digital proxy to data associated with a user and sharing the data by the surrogate is then presented and described.

### Notation and Nomenclature

Some portions of the detailed descriptions which follow are presented in terms of procedures, logic blocks, processes, modules and other symbolic representations of operations on data bits within a computer memory. These descriptions and representations are the means used by those skilled in the data processing arts to most effectively convey the substance of their work to others skilled in the art. In the present application, a procedure, logic block, process, module, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device/component.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “authenticating,” “generating,” “accessing,” “verifying,” “confirming,” “reconfirming,” “adding,” “receiving,” “generating a single-usc datastore token,” “identifying,” “providing,” “employing,” “sending,” “storing,” “transmitting,” “instruction,” “encrypting,” “decrypting,” or the like, refer to the actions and processes of an electronic device or component such as (and not limited to): a processor, a plurality of distributed processors, a memory, a computer, an authentication server, a data storage server, an encrypted datastore, some combination thereof, or the like. The electronic device/component manipulates and transforms data represented as physical (electronic and/or magnetic) quantities within the registers and/or memories into other data similarly represented as physical quantities within memories and/or registers or other such information storage, transmission, processing, and/or display components.

Embodiments described herein may be discussed in the general context of processor-executable instructions residing on some form of non-transitory processor-readable medium, such as program modules or logic, executed by one or more computers, processors, or other devices. Generally, program modules include routines, programs, objects, components, data structures, etc., that perform particular tasks or implement particular abstract data types. The functionality of the program modules may be combined or distributed, as desired, in various embodiments. In some embodiments, one or more aspects may also be practiced in distributed computing environments where tasks are performed by remote processing devices that are linked through a communications network. In a distributed computing environment, program modules may be located in both local and remote computer-storage media including memory-storage devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example electronic device(s) described herein may include components other than those shown, including well-known components.

The techniques described herein may be implemented in hardware, or a combination of hardware with firmware and/or software, unless specifically described as being implemented in a specific manner. Any features described as modules or components may also be implemented together in an integrated logic device or separately as discrete but interoperable logic devices. If implemented in software, the techniques may be realized at least in part by a non-transitory computer/processor-readable storage medium comprising computer/processor-readable instructions that, when executed, cause a processor and/or other components of a computer, computer system, or electronic device to perform one or more of the methods and/or actions of a method described herein. The non-transitory computer/processor-readable storage medium may form part of a computer program product, which may include packaging materials.

The non-transitory processor-readable storage medium (also referred to as a non-transitory computer-readable storage medium) may comprise random access memory (RAM) such as synchronous dynamic random access memory (SDRAM), read only memory (ROM), non-volatile random access memory (NVRAM), electrically erasable programmable read-only memory (EEPROM), flash memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules (i.e., program modules) or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a plurality of microprocessors, one or more microprocessors in conjunction with an ASIC or DSP, or any other such configuration or suitable combination of processors.

### Example System for Surrogate Authentication and Data Sharing

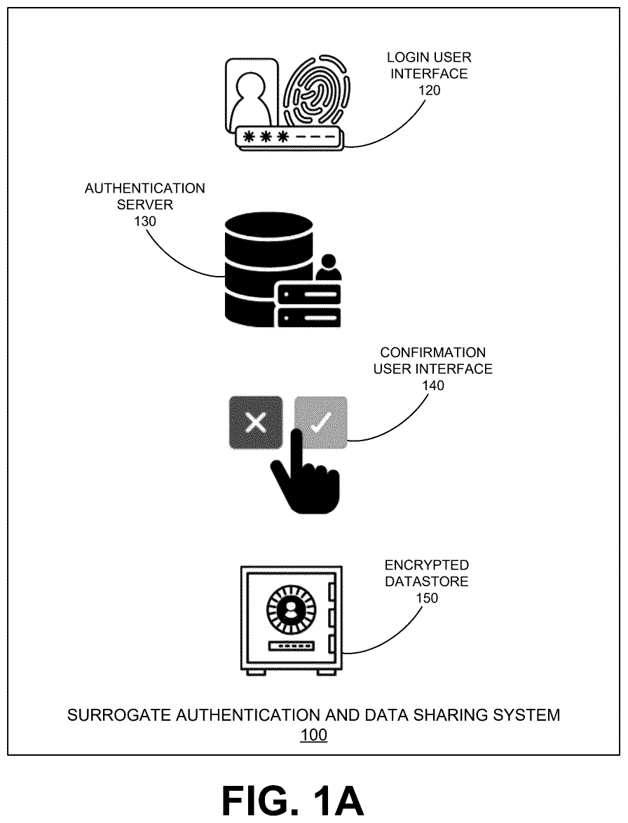

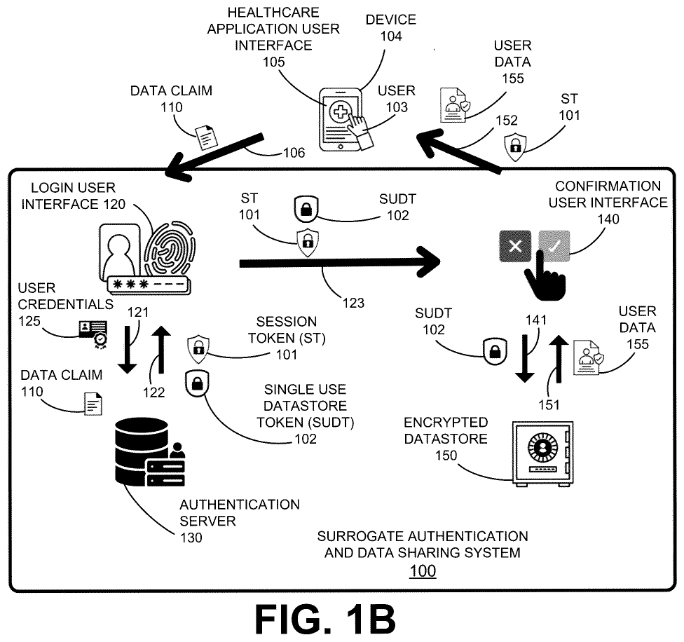

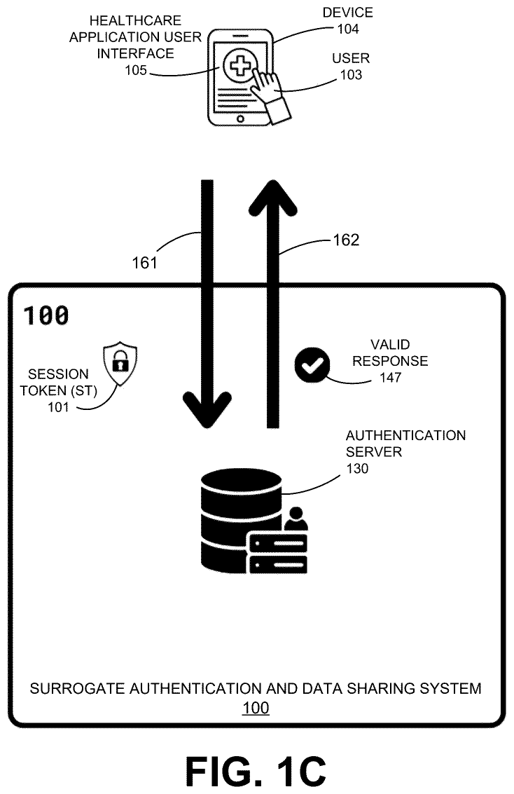

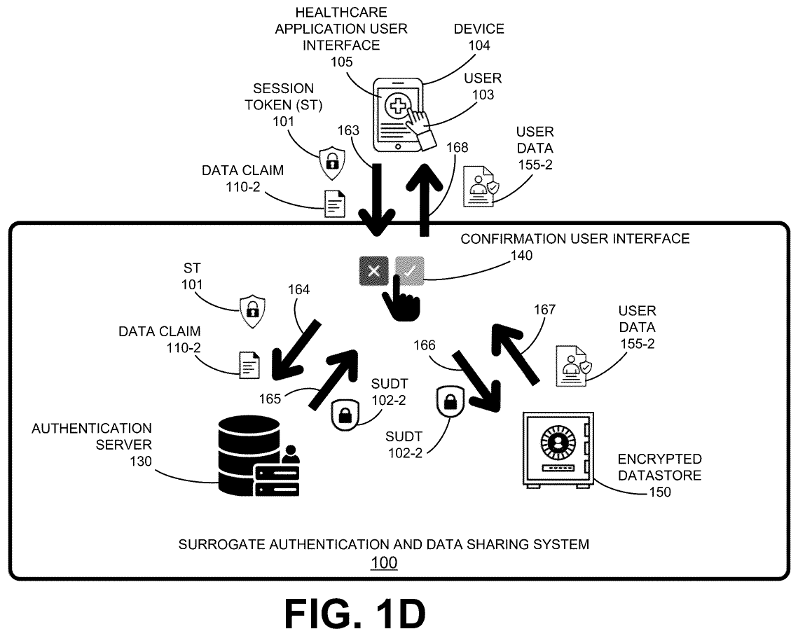

FIG. 1A illustrates an example system 100 for surrogate authentication and data sharing, in accordance with various embodiments. In various embodiments system 100 includes one or more of: a login user interface 120; an authentication server 130; a confirmation user interface 140; and an encrypted datastore 150. The illustrated components may be communicatively coupled, such as by a computer network or other electronic communication, to facilitate interchange of information between the various components. With continued reference to FIG. 1A (and also to FIGS. 1B, 1C, and 1D), system 100 introduces an innovative approach to healthcare data management by integrating a data-sharing at time of authentication model, enabling authorized surrogates to share user data on behalf of others.

A login user interface 120, as used herein, is a screen or page which is presented on healthcare application user interface 105 or a third party user interface and through which an entity, such as an entity, such as user 103, enters their credentials 125 (like username and password; facial identification, fingerprint, or other biometric; single sign on credentials; etc.) to access system 100. An “entity” may be, for example, a user, surrogate, device, application, etc. which is seeking access to system 100. In the examples herein, the entity is often referred to as user 103. User login interface 120 typically includes one or more fields for entering credentials 125. Once entered, the credentials 125 are supplied to authentication server 130 which validates their authenticity as being associated with a particular user. The login user interface (UI) 120, as shown in FIGS. 1A, 1B, 1C, and 1D, is a UI provided by system 100. The login UI 120 is designed to provide a seamless and secure experience, enabling patients and authorized surrogates, such as parents or guardians, to manage data access and permissions effectively. Users can determine which healthcare providers or applications can request their PHI and non-clinical data and under what conditions, ensuring autonomy over their information.

An authentication server 130, as used herein, is a computer system or software running on a computer system which is responsible for verifying the identity of an entity (user, surrogate, device, application, etc.) which is seeking access (in this case access to encrypted datastore 150). Authentication server 130 acts as a gatekeeper to encrypted datastore 150 by verifying authenticity of credentials 125 provided by an entity (user, surrogate, device, application, etc.), and, upon verification, issuing both a session token 101 and a single-use datastore token 102. The role of authentication server 130 in system 100 is verifying the identities of entities (users, surrogates, devices, applications, etc.) attempting to access data from encrypted datastore 150. Authentication server 130 employs robust multi-factor authentication (MFA) protocols, ensuring accurate identity verification and continuous monitoring of requests, aligning with data sharing principles and also allows for Single Sign-On (SSO) to multiple healthcare data systems (which may also be referred to as patient portals) with the same credentials. In some embodiments, as previously described, authentication server 130, records information about authentication attempts, authentication verifications, data access transactions issuance of session tokens, issuance of private keys, and/or issuance of single-use datastore tokens in various records of these activities. In some embodiments, authentication server 130 records one or more of these or other records as a hashed transaction on a blockchain. Such recordings of records on a blockchain provide for future audit of activities of authentication server 130 without the risk of alteration.

A confirmation user interface 140, as used herein, is a screen or dialog presented by system 100 via an application user interface 105, for example, that asks an entity such as user 103 to verify or confirm an action before it is completed. Use of confirmation user interface 140 during a session is implemented to prevent accidental actions and ensure that an entity, such as user 103, is making an intentional choice. In some embodiments, confirmation user interface 140 may present a message describing the action which needs to be confirmed along with selection options, such as user selectable buttons, for confirming or cancelling the action. Visual cues, such as colors (e.g., red for cancelling an action, green for confirming the action) and/or icons (e.g., a “X” icon for cancelling an action, a checkmark icon for confirming action) may be integrated with the selection options to facilitate intuitive responses to any presented dialog/message about an action for which confirmation of an entity (e.g., user 103) is requested.

An encrypted datastore 150, as used herein, is a secure storage system, such as a data storage server, where data is stored in an encrypted state, meaning it's transformed into an unreadable format, ensuring that it can only be accessed or deciphered by individuals or systems with the correct decryption key, such as a single-use datastore token 102. Encrypted datastore 150 is a repository for data that is owned by a user but, in the past, typically not possessed by that user. For example, when PHI data for a user is generated at a hospital, doctor's office, dentist office, etc., the user owns the data but likely does not possess it if it is stored electronically by the hospital, doctor's office, dentist office etc. Encrypted datastore 150, in some embodiments, is a third-party to the point of generation/original storage of PHI and is populated with user data obtained by electronic health records (for example) that have been obtained by data/records requests from the hospital, doctor's office, dentist office, etc. where the health data was originally generated. In this manner, data owned by a plurality of different users and sourced from a plurality of disparate originating sources (different doctor's offices, different health provider networks, different hospitals, etc.) may be stored in a single encrypted datastore for access and control by the individual users of the plurality to whom respective PHI belongs.

Regarding encrypted datastore 150, the encryption of the stored data protects sensitive information, such as personal, financial, health, or confidential business data, from unauthorized access. Accordingly, even if an unauthorized entity were to gain access to encrypted datastore 150, the encryption ensures the data within encrypted datastore 150 remains protected and unusable without the proper key. The encrypted datastore 150, as shown in FIGS. 1A, 1B, and 1D, is a database which securely stores both PHI and non-clinical user data. This encrypted database employs advanced encryption protocols to protect information. In some embodiments, the encrypted datastore 150 is decoupled from the authentication server 130 and user data stored within it in an encrypted fashion can be stored either online or offline, provided it is accessible at time of authentication. The encrypted datastore 150 requires a private key (e.g., a single-use datastore token 102) to gain access. In some embodiments, this private key can also be used to generate revocable shared private keys that can be used by authentication server(s) 130 to gain access to the encrypted datastore 150. Encrypted datastore 150 is storage-agnostic, meaning it can be implemented using traditional databases (e.g., PostgreSQL with AES-256 encryption, for example) or blockchain-based decentralized storage (e.g., IPFS+encryption keys, for example). Encrypted datastore 150 does not store the private key itself; instead, it uses ephemeral decryption keys which are private keys issued only when an authentication server 130 verifies access. In some embodiments, encrypted datastore 150 may record any data access event (or attempt at data access) on a blockchain, such as a hashed transaction on the blockchain. Such recordings on a blockchain provide for future audit of data access events of encrypted datastore 150 without the risk of alteration.

FIGS. 1B, 1C, and 1D illustrate diagrammatic views of the architecture of system 100 in a manner which showcases the main components (login user interface 120; authentication server 130; confirmation user interface 140; and encrypted datastore 150) and the workflow of data. For example, these diagrammatic views illustrate authentication server 130, encrypted datastore 150, login user interface 120, and confirmation user interface 140 with an emphasis on how these components fit within an authentication flow to enable and facilitate dynamic, authentication-based data sharing with a decoupled encrypted datastore 150. It should be appreciated that, in some embodiments, rather than being decoupled from the physical location of other components of system 100, one or more encrypted datastores 150 may be maintained on or implemented as one or more data storage servers which is/are also a part of system 100.

A session token 101 (ST 101), as used herein, is a unique temporary identifier issued by authentication server 130 to an entity (e.g., a user, a surrogate, a device, and/or an application) after authentication of the credentials of the entity. ST 101 may also be referred to as a session identification or an authentication token. By “temporary,” what is meant is that an issued ST 101 expires after a preset amount of time, such as one minute, five minutes, fifteen minutes, etc. and/or after a predetermined amount of inactivity in a session of interaction with system 100. A ST 101 is used to maintain a session (i.e., a continual series of actions and/or time-bounded collection of actions) of the entity with system 100, thus eliminating the need to reenter credentials and reauthenticate the entity for every interaction with system 100 by the entity during the session. In this manner, ST 101 helps balance security of system 100 with convenience of access by an entity which is interacting with system 100. ST 101, in some embodiments, may be as simple as a random string of characters generated by authentication server 130 and sent to the login user interface 120 being used by the entity to gain access to system 100. After receipt of the ST 101, an application user interface 105 (or an application or device 104 on which it is presented, includes the ST 101 in subsequent interactions for the entity (i.e., user 103), during a session of accessing system 100, to prove it is authenticated to access system 100.

A single-use datastore token 102 (SUDT 102), operates similarly to a one-time password but is used for accessing and interacting with an encrypted datastore 150 instead of logging into an account. An SUDT 102, as used herein, is an irreversible single-use token which is created by the authentication server 130. In some embodiments, SUDT 102 also comprises embedded instructions which may include, without limitation thereto: 1) instructions for which datastore of a plurality of datastores has been requested to be decrypted; 2) instructions/key for decrypting the datastore; and/or 3) instructions to a third-party application (e.g., a healthcare application at a healthcare provider) to which the encrypted data or decrypted data (after decryption) is to be sent. In some embodiments additional or alternative instructions may be included on the SUDT 102. For example, in one embodiment, the SUDT 102 additionally or alternatively includes instructions for how to send encrypted or decrypted data from the encrypted datastore 150 to a third-party application, such as an application operating on device 104. After being used once, SUDT 102 becomes invalid, ensuring security or controlled access to encrypted datastore 150.

In some embodiments some other examples of instructions which may be included in SUDT 102, sometimes as additional tokens. Some of these instructions may limit access, specify types of access, or increase security of user data. Some non-limiting examples of such instructions may additionally or alternatively include one or more of instructions regarding: 1) a time frame (i.e., window of time) in the history of user data for which a surrogate is authorized to access user data in encrypted datastore 150 (e.g., user data for the last two months, user data for the last year, for the last two years, user data between two dates, all user data user data, etc.); 2) a time limit for how long the surrogate will be permitted access to user data (e.g., one day, a specific date range, a week, a month, open-ended); 3) granular controls on which data a surrogate is allowed to access (e.g., only from a specified doctor, only from a specified hospital, only from a specified clinic, only from a specified insurance company, all data from any point of origin, etc.); 4) control on what a surrogate can do with the actual user data (e.g., create/add more user data, add or not add additional surrogates, read existing user data and electronically share it other entities, read user data but not electronically share it to other entities, update existing user data, electronically transmit user information, destroy existing user data, etc.); 5) destinations a surrogate is permitted to electronically share user data with (e.g., only to two specific doctors, only to one specific doctor, only to a specific hospital, only to a specific medical clinic, only to a specific insurance company and a specific hospital, anywhere with no limit, etc.); 6) the number of times that a surrogate is allowed to access data while acting as a surrogate (e.g., 5 times, 10 times, no limit, etc.); 7) the device/location from which a surrogate is permitted to access user data (e.g., limited to an IP address, limited to a device with a particular identifier, limited to a software instantiation with a particular identifier, no limit, etc.); and/or 8) one or more geographic locations from which a user can access (e.g., when within a geofence associated with a particular hospital, when within a geofence associated with a specific medical clinic, when within a geofence associated with a specific doctor's office, when within a geofence associated with a home of record of the surrogate, when within a geofence associated with a work location of the surrogate, when within a geofence associated with a town where the surrogate lives, etc.). In some embodiments, a user may be presented with a menu of selectable instructions by login user interface 120. In some embodiments, a user may type narrative instructions which are then interpreted and implemented as instructions (which are included in SUDT 102) by an artificial intelligence such as a large language module (i.e., a chat generative pre-trained transformer) which is coupled with login user interface 120.

FIG. 1B demonstrates the architecture and workflow of authentication and updating or requesting user data through a data claim, user credentials, a session token (ST) 101, and a single-use datastore token 102 within system 100, in accordance with various embodiments.

Starting in the top center of FIG. 1B, an entity, such as user 103, utilizes a healthcare application user interface 105 on a device 104 (e.g., a computer, tablet computer, smartphone, or the like) which is running the application on which the user interface 105 is presented. As illustrated by arrow 106, the user 103 employs the device 104 and the healthcare application UI 105 operating thereon to present a data claim 110 to system 100. The data claim is a claim to PHI, such as one or more HCRs, that that belongs to or is associated with user 103. In response to the presentation of data claim 110, system 100 presents a login user interface 120 to user 103, for example on a display of device 104 or within healthcare application UI 105 on device 104. Responsive to user 103 providing credentials (e.g., user identification plus a password or biometric), login user interface 120 sends the user credentials 125 and the data claim 110 to authentication server 130 as illustrated by arrow 121. Responsive to authenticating the user credentials 125 and the rights of user 103 to access the data described by data claim 110, authentication server 130 creates both ST 101 and SUDT 102. As illustrated by arrow 122, ST 101 and SUDT 102 are provided to login user interface 120 and/or device 104 (or the health care application user interface 105 operating thereon) for use during the session of accessing system 100. In some embodiments, the SUDT 102 may include instructions for an encrypted datastore 150. One example of such instructions would be instructions about which user data 155 (as may have been specified by data claim 110 or as associated with user 103) is permitted to be accessed by device 104 and/or health care application user interface 105 during the session encompassed by ST 101. Other instructions, as previously described, may be additionally or alternatively be included in SUDT 102. As illustrated by arrow 123, the ST 101 and SUDT 102 are forwarded from login user interface 120 and trigger the presentation to user 103 of a confirmation user interface 140. The confirmation user interface 140 may be presented on a display of device 104 and/or within health care application user interface 105 which is operating on device 104. Confirmation user interface 140 presents the user with selectable inputs (e.g., buttons, icons, or the like) for either cancelling the data claim 110 or confirming/proceeding with the data claim 110. As indicated by arrow 141, in response to the user confirming the actions associated with data claim 110, SUDT 102 is forwarded to encrypted datastore 150. In some embodiments, confirmation user interface 140 may be omitted and SUDT 102 may be sent directly from authentication server 130 to encrypted datastore 150.

As shown by arrows 151 and 152, encrypted datastore 150 responds to receipt of SUDT 102 by sending out user data 155 which had been requested via the initial data claim 110. The user data 155, may be decrypted by encrypted datastore 150 and sent decrypted, in some embodiments. User data 155 is communicated to device 104, either directly or via confirmation user interface 140, as part of the session associated with ST 101. Once on device 104, user data 155, may be displayed on a display of device 104 and/or within a healthcare application user interface 105 operating on device 104. In some embodiments, the session associated with ST 101 ends when user data 155 is supplied to device 104.

FIG. 1C represents the architecture and workflow of reverifying a session token 101 by the healthcare application within system 100, in accordance with various embodiments. In some instances, after a present amount of time has passed or for other security reasons, authentication server 130 may require health application user interface 105 to reconfirm a session and that health application user interface 105/device 104 are legitimately participating in the session. In response, as illustrated by arrow 161, health application user interface 105 provides session token 101 (which had previously been sent to health application user interface 105 after initial authentication in the manner illustrated in FIG. 1B). As illustrated by arrow 162, when the correct ST 101 is received by authentication server 130 authentication server confirms to health application user interface 105 that a valid response 147 was provided, and the current session between device 104 and system 100 is allowed to continue without re-authentication via login user interface 120.

FIG. 1D represents the architecture and workflow of updating or requesting user data through a data claim 110-2 with an existing session token 101 within system 100, in accordance with various embodiments. The process in FIG. 1D is similar to the process illustrated in FIG. 1B, except that initial authentication has already taken place and caused system 100 to generate ST 101. Accordingly, when a second data claim 110-2 is presented within the existing session it is processed by system 100 using the existing ST 101 for authentication of the session, without requiring a second verification of user credentials 125 via login user interface 120.

With continued reference to FIG. 1D, beginning in the upper middle, an entity such as a user 103 operates a health care application user interface 105 on a device (e.g., device 104 or other computing device) to generate a second data claim 110-2 to system 100. As shown by arrow 163, the second data claim 110-2 is sent to system 100 along with the existing ST 101. In various embodiments, the second data claim 110-2 and the ST 101 are received by confirmation user interface 140 and forwarded to authentication server 130 (as illustrated by arrow 164) or just sent directly to authentication server 164 without confirmation user interface 140 as an intermediary. In response to authenticating ST 101, authentication server 130 creates and issues a second SUDT 102-2. As shown by arrows 164 and 166, and in response to a confirmation provided by user 103, SUDT 102-2 is then routed to encrypted datastore 150 via confirmation user interface 140. Encrypted datastore 150 retrieves the encrypted PHI data (or other encrypted data) associated with data claim 110-2 and SUDT 102-2 and outputs it as user data 155-2. As illustrated by arrows 167 and 168, user data 155-2 is then routed to health application user interface 105, either directly or vis confirmation user interface 140, device 104 so that it may be displayed to user 103.

### Methods of Surrogate Authentication and Data Sharing

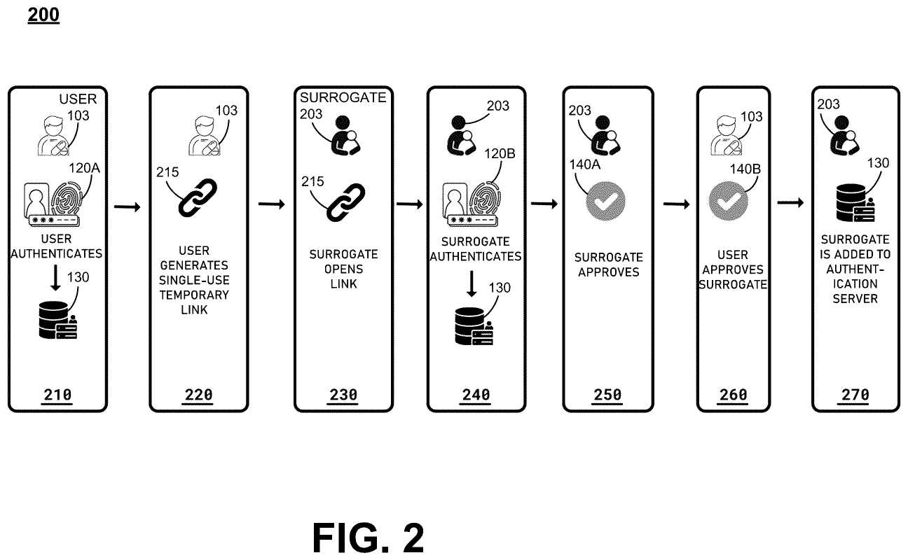

FIG. 2 illustrates a flow diagram 200 of an example method, which uses one or more components of system 100, of adding a surrogate 203, and also shows how an authenticated user 103 can generate a single-use temporary link 215 (SUTL 215) that can be used by a surrogate 203 to be added to the authentication server, in accordance with various embodiments. A surrogate 203, as used herein, is a second entity (such as another person) who is authorized to access PHI or other sensitive or protected data on behalf of a first entity (i.e., on behalf of user 103).

At 210 of flow diagram 200 of FIG. 2, the process begins with the user 103 authenticating themselves with the authentication server 130 via login user interface 120A. This authentication establishes the user's identity and begins the session. The process for conducting such authentication was previously discussed in conjunction with the description of some of the activities depicted in FIG. 1B.

At 220 of flow diagram 200 of FIG. 2, the authenticated user 103 generates a single-use temporary link 215. SUTL 215 serves as a secure invitation for another (e.g., a second person such as surrogate 203) to accept the role of a surrogate (with respect to data held in an encrypted datastore 150) for the user 103.

At 230 of flow diagram 200 of FIG. 2, the surrogate 203 receives and opens the single-use temporary link 215. This action initiates the surrogate's 203 part of the authentication process. The surrogate may open the SUTL 215 on the same application user interface and/or device as was used by user 103 to send the authenticate and initiate the sending of the SUTL 215, but more typically opens the SUTL 215 on a different device than the device being used by user 103. The user 103 and the surrogate 203 may be physically separated (i.e., in different rooms or even different cities or countries from one anther). SUTL 215 may be sent to a specific user interface that is accessible by surrogate 203, or may be sent by other means such as a text message, instant message, email, etc. When surrogate 203 opens SUTL 215 it initiates a communication with system 100 such that a login user interface 120B, provided by system 100, is presented on the device which was used by surrogate 203 to open SUTL 215.

At 240 of flow diagram 200 of FIG. 2, the surrogate 203 authenticates themselves with the authentication server 130, via login user interface 120B, similar to the initial user authentication described in procedure 210 and in conjunction with the authentication described in FIG. 1B. This procedure verifies the identity of surrogate 203 to system 100.

At 250 of flow diagram 200 of FIG. 2, the surrogate's authentication is approved. The surrogate 203 user accepts the role of a surrogate 203 for user 103 such as by clicking on an appropriate selectable button provided by a confirmation user interface 140A that is presented by system 100 to surrogate 203 on the device being used by surrogate 203.

At 260 of flow diagram 200 of FIG. 2, the original user 103 approves the surrogate 203 as an approved surrogate user 203. The user 103 approves the surrogate 203 by clicking on an appropriate selectable button provided by a confirmation user interface 140B that is presented by system 100 to user 103 on the device 104 being used by user 103. This double-confirmation ensures that the user 103 consents to the access being afforded to surrogate 203.

At 270 of flow diagram 200 of FIG. 2, the surrogate 203 is successfully added to the authentication server 130, completing the process. The surrogate 203 now has the necessary permissions to act on behalf of the user 103 and can login to system 100 and send data claims 110 on behalf of the user 103 in the same manner as illustrated in FIG. 1B, as if the surrogate is actually user 103.

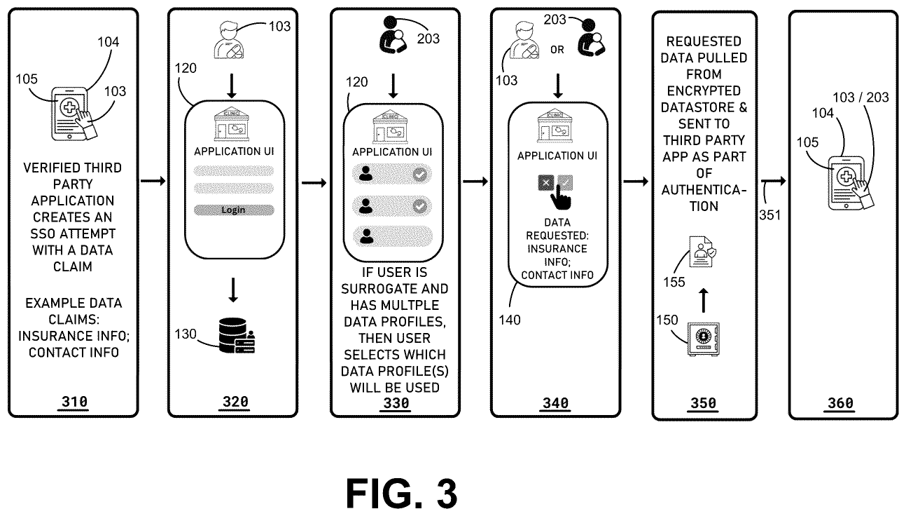

FIG. 3 is a flow diagram 300 of an example method, which uses one or more components of system 100, of enabling users or a surrogate to share user data. Flow diagram 300 shows the procedures involved in authenticating users 103 or surrogates 203, setting granular data access permissions, and securely sending requested data, in accordance with various embodiments.

Login and confirmation flow are also illustrated in FIG. 3, and the depicted flow diagram 300 highlights user or surrogate authentication via the login user UI 120, followed by the authentication server's 130 verification process. Upon successful authentication, users 103 or surrogates 203 manage data access permissions, with each request processed in real-time through the authentication server 130, ensuring secure and accurate data sharing.

At 310 of flow diagram 300 of FIG. 3, the healthcare application user interface (UI) 105 initiates a Single Sign-On (SSO) attempt, creating a data claim (e.g., a data claim 110 as described in connection with FIG. 1B) which includes a request for specific data such as insurance information and contact details. The healthcare application (UI) 105 is a “verified application,” meaning that it has been approved and verified and thus allowed to access system 100 to initiate a data claim.

At 320 of flow diagram 300 of FIG. 3, the authentication server 130 processes the SSO attempt by verifying the credentials provided and the integrity of the data claim initiated by the user 103 or healthcare application UI 105. The user 103 may interact with a login user interface 120 to provide credentials, in some embodiments.

At 330 of flow diagram 300 of FIG. 3, following authentication by authentication server 130, if the “user” is a surrogate 203 (e.g., a surrogate authorized in the manner illustrated in flow diagram 200) or has multiple user data profiles, they select which specific data profiles will be shared, granting consent for each. In some embodiments, this selection of data profiles is made via a confirmation user interface 140 which is presented by system 100 on device 104 or health application UI 105. If the user is not a surrogate or does not have multiple data profiles, this procedure may be omitted.

At 340 of flow diagram 300 of FIG. 3, system 100 delineates the scenario where either the user 103 or the surrogate 203 makes decisions regarding data access permissions, ensuring the request aligns with the pre-set permissions and the user's preferences. In some embodiments, these decisions are confirmed by the user 103 or surrogate 203 via a confirmation user interface 140 which is presented by system 100 on device 104 or health application UI 105.

At 350 of flow diagram 300 of FIG. 3, the user data which was described by the data claim in procedure 310 is retrieved from an encrypted datastore 150, is located by encrypted datastore 150 and output as user data 155. System 100 ensures that sensitive information in user data 155 is transmitted securely and in compliance with data protection regulations.

At 360 of flow diagram 300 of FIG. 3, the healthcare application's UI receives the user data 155 which was requested by the data claim in procedure 310. The user data 155 is securely processed and transmitted, allowing for the continuation of healthcare services with the authenticated user 103 or authenticated surrogate 203, whichever is operation g device 104.

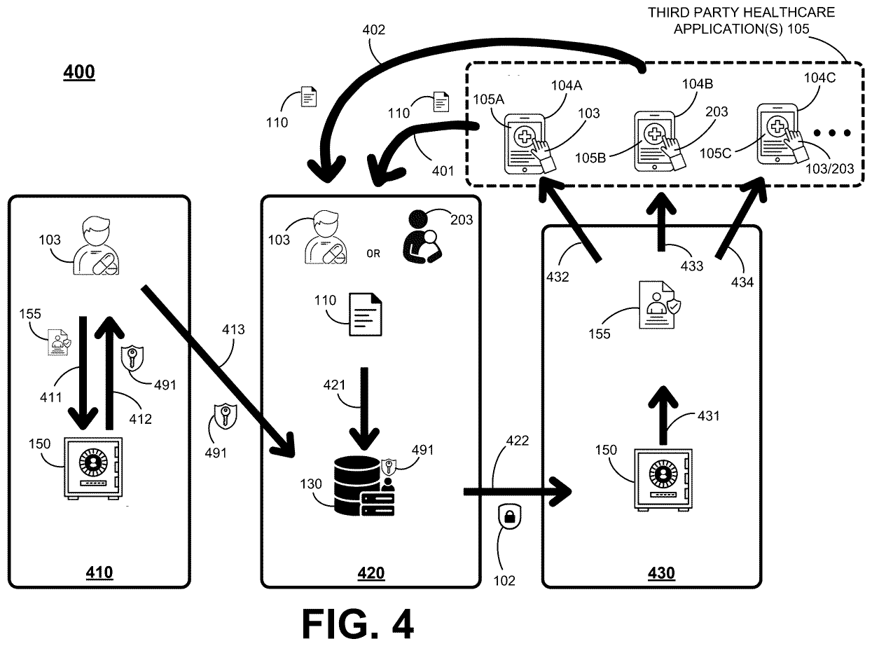

FIG. 4 illustrates a flow diagram 400 explaining, at a high level, procedures, which use one or more components of the system 100 (such as an authentication server 130), to first receive a private key for secure access to the encrypted datastore 150 and then use that private key to manage, decrypt, and share user data from the encrypted datastore 150 to one or more of a plurality of third-party applications. For example, each of the plurality of third-party application user interfaces 105 (105A, 105B, 105C)) may be associated with a respective healthcare application of one of a plurality of different healthcare data systems of doctor's offices, clinics, hospitals, or the like. The third-party application user interfaces 105 may be associated with other types of applications, such as: an insurance application of an insurance data system; a financial application of a financial data system; or a legal application of a judicial data system. As depicted, one or more of the third-party application(s) 105 makes a data claim 110 for sensitive data of a user 103, which has been previously provided by the user 103 to the authentication server. Some non-limiting examples of the data include, without limitation thereto: PHI data, PHR data, non-clinical data, insurance data, judicial data, and financial data.

Surrogate authentication is a technique facilitated by system 100 and represented in FIG. 4. Surrogate authentication enables designated individuals, such as parents of minor children, legal guardians, domestic partners, non-marital spouses, and/or appointed/designated representatives, to authenticate and manage data on behalf of other users, acting as a digital proxy akin to a power of attorney. Examples herein depict and describe a parent or legal guardian as the surrogate, but as indicated a surrogate may fall into many other categories. Surrogate authentication, as performed by system 100, includes stringent verification processes to confirm and validate the surrogate's authorization, thus maintaining the integrity and the user's security. This form of authentication allows for the creation and management of data profiles for dependents, such as children, with surrogates overseeing these profiles until the dependents are of age or capability to manage their own data. Once the appropriate time arrives, the profile can be smoothly transitioned to the individual, facilitating a seamless handover of data management responsibilities and promoting independence and personal data stewardship. Additionally, when integrated with legal frameworks, this surrogate authentication can encompass actual power of attorney responsibilities, provided the authentication server incorporates the necessary legal protocols and verifications to ensure compliance and enforceability in legal contexts. This legal integration would enhance the surrogate's ability to make decisions and take actions that are legally recognized, further aligning the digital surrogate role with its real-world legal counterpart.

At 410 of flow diagram 400 of FIG. 4, as illustrated by arrow 411, user 103 provides sensitive user data 155 for storage in encrypted datastore 150. Either simultaneously, or at some future time, user 103 provides their shared private key 491 or else authorized encrypted datastore 150 to share the shared private key 491, which grants secure access to the encrypted datastore 150. The shared private key 491 is used by encrypted datastore 150 for encrypting and decrypting this user data 155. Arrow 412 shows the shared private key 491 being output from encrypted datastore 150. Arrow 413 shows the shared private key (either provided by user 103 or by encrypted datastore 150) being shared to authentication server 130.

At 420 of flow diagram 400 of FIG. 4, as illustrated by arrows 401, 402 and 421 the authentication server 130 receives one or more data claims 110 from one or more heath application UIs 105 (e.g., from UI 105A and UI 105B). The data claims 110 originate from either the user 103 or a designated surrogate 203 of user 103. With the private key 491, which was previously provided and stored, the authentication server 130 can securely manage the user data within the encrypted datastore 150, ensuring that all subsequent data sharing and management operations are securely authenticated. For example, in some embodiments, authentication server 130 can create a single-use datastore token 102 which includes instructions and private key 491 and then send this SUDT 102, as illustrated by arrow 422, to encrypted datastore 150.

At 430 of flow diagram 400 of FIG. 4, once the authentication server 130 has access to the encrypted data, it manages and shares the user data 155 (as requested in data claims 110) with various healthcare applications (e.g., it may send it to one or more of health care applications associated with UIs 105A, 105B, 105C, or the devices 104A, 104B, 104C associated with them). The data is shared in a controlled and secure manner as illustrated by arrows 431, 432, 433, and 434, ensuring that each healthcare application receives the necessary user data 155 to provide services without compromising the security of the user's sensitive information. For example, when a surrogate 203 or the user 103 presents a data claim 110 from a third-party application to the authentication server 130, the authentication server 130 can provide one or more of: a SUDT 102 (as described in FIG. 1B) with instructions for which encrypted datastore 150 from which the user data 155 should be decrypted; instructions or a private key 491 for performing the decryption; and directions for sending the decrypted data as user data 155 to one or more particular third-party applications (e.g., it may send it to one or more of health care applications associated with UIs 105A, 105B, 105C, or the devices 104A, 104B, 104C associated with them) from which the data claims 110 originated or to which data was directed to be sent by the user 103 or surrogate 203 who initiated the data claims 110. This process can be repeated with the same encrypted datastore 150 and other third-party applications which present a data claim 110 via the user 103 or the surrogate 203 of the user 103.

With reference to both FIG. 2 and FIG. 4, it can thus be appreciated that the ability of adding an authorized surrogate 203 for user data and authentication, represented by the diagram in FIG. 2, and the ability to share user data 155 to multiple heath care data systems, represented by the diagram in FIG. 4, marks a significant leap forward in data management afforded to a user 103 and/or a surrogate 203 of the user 103. It not only safeguards user data 155 but also empowers a user 103 and their authorized surrogate(s) 203 with unprecedented control over data access, ushering in a new era of user-centered, secure, and efficient data management.

By incorporating a storage, database, or blockchain agnostic encrypted datastore 150, the system 100 enables secure and transparent sharing of both PHI and non-clinical user data (and other personal or sensitive user data) across various platforms without reliance on specific storage technology (such as a proprietary database). This design ensures the scalability and adaptability of system 100 to evolving data management technologies.

By granting patients the ability to specify granular permission for their PHI and non-clinical user data (and/or other sensitive or personal user data) on a case-by-case basis, the system 100 empowers patients, fostering a more secure, efficient, and patient-centered healthcare data management ecosystem. This approach not only protects patient data but also enhances user experience, promoting more interactive and trust-based relationships between patients and healthcare providers.

The techniques described herein emphasize the advanced capability of system 100 to provide robust security and enhanced user control over PHI and non-clinical user data (and other sensitive or personal user data) through system 100, representing a significant innovation in healthcare data management. While the examples used focus on PHI and healthcare data, other types of sensitive user data such as financial data, tax data, security classified data, and the like may be shared to third party applications/systems and/or shared to or via instructions provided by an authenticated surrogate in a similar fashion.

### Example Computer System Environment

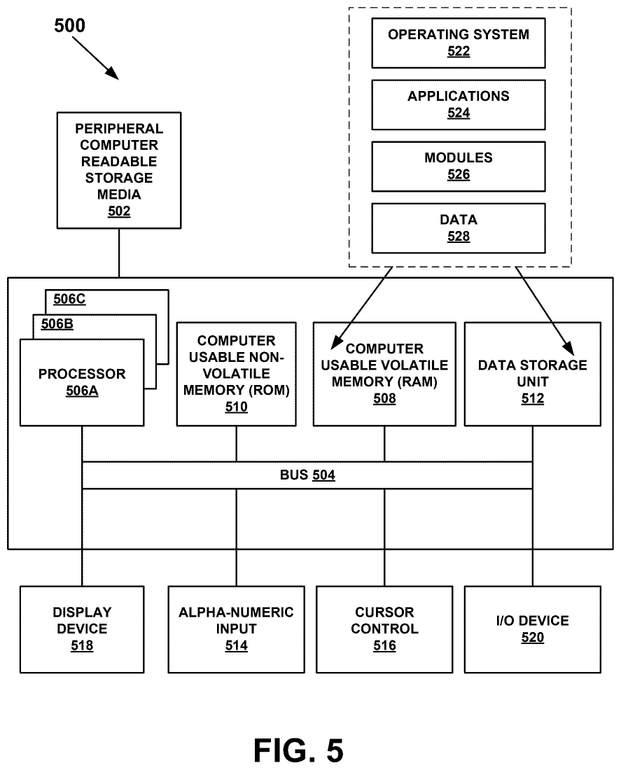

With reference to FIG. 5, all or portions of some embodiments described herein are composed of computer-readable and computer-executable instructions that reside, for example, in computer-usable/computer-readable storage media of a computer system. That is, FIG. 5 illustrates one example of a type of computer (computer system 500) that can be used in accordance with or to implement various embodiments, such as system 100, login user interface 120, authentication server 130, confirmation user interface 140, encrypted datastore 150, and/or user device 104, which are discussed herein.

It is appreciated that computer system 500 of FIG. 5 is only an example and that embodiments as described herein can operate on or within a number of different computer systems including, but not limited to, general purpose networked computer systems, embedded computer systems, routers, switches, server devices, client devices, various intermediate devices/nodes, standalone computer systems, media centers, handheld computer systems, multi-media devices, and the like. Computer system 500 of FIG. 5 is well adapted to having peripheral tangible computer-readable storage media 502 such as, for example, a floppy disk, a compact disc, digital versatile disc, other disc-based storage, universal serial bus “thumb” drive, removable memory card, and the like coupled thereto. The tangible computer-readable storage media is non-transitory in nature.

System 500 of FIG. 5 includes an address/data bus 504 for communicating information, and a processor 506A coupled with bus 504 for processing information and instructions. As depicted in FIG. 5, system 500 is also well suited to a multi-processor environment in which a plurality of processors 506 (506A, 506B, and 506C) are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g., random access memory (RAM), coupled with bus 504 for storing information and instructions for processors 506A, 506B, and 506C. System 500 also includes computer usable non-volatile memory 510, e.g., read only memory (ROM), coupled with bus 504 for storing static information and instructions for processors 506A, 506B, and 506C. Also present in system 500 is a data storage unit 512 (e.g., a magnetic or optical disk and disk drive) coupled with bus 504 for storing information and instructions. System 500 also includes an optional alphanumeric input device 514 including alphanumeric and function keys coupled with bus 504 for communicating information and command selections to processor 506A or processors 506A, 506B, and 506C. System 500 also includes an optional cursor control device 516 coupled with bus 504 for communicating user input information and command selections to processor 506A or processors 506A, 506B, and 506C. In one embodiment, system 500 also includes an optional display device 518 coupled with bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch screen, touch pad, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules (i.e., program modules) 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

Computing system 500 is only one example of a suitable computing environment and is not intended to suggest any limitation as to the scope of use or functionality of the present technology. Neither should the computing environment of the subject matter be interpreted as having any dependency or requirement relating to any one or combination of components illustrated in the example computing system 500.

### Example Methods of Operation

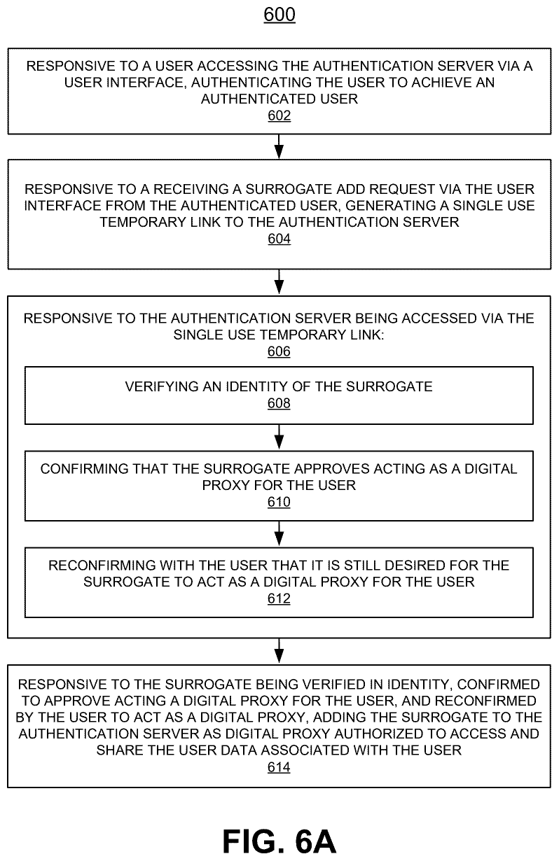

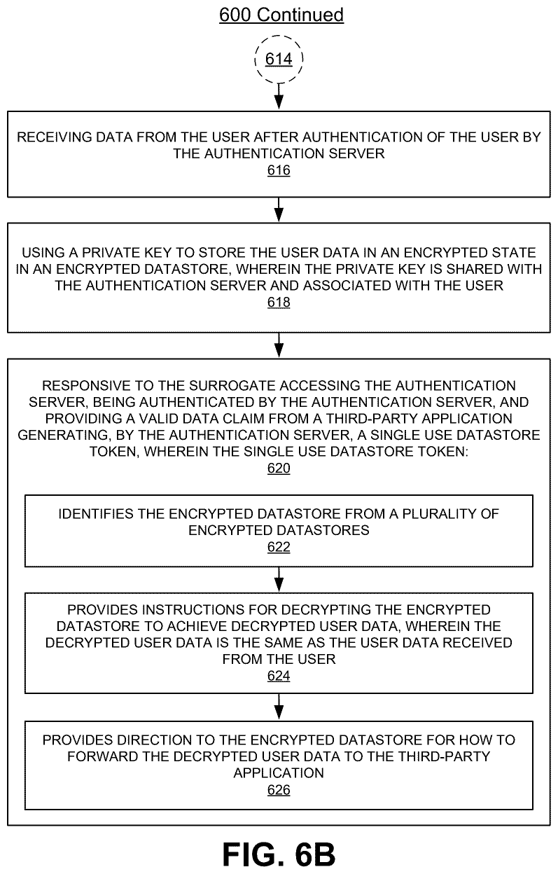

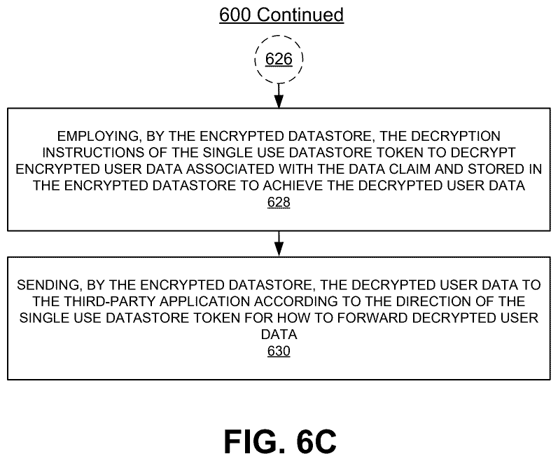

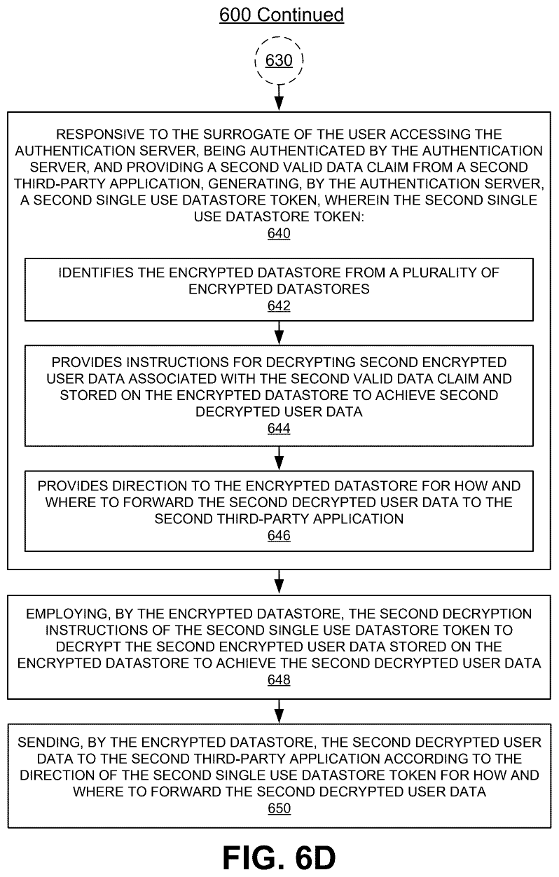

The following discussion sets forth in detail the operation of some example methods of operation. With reference to FIGS. 6A-6D, flow diagram 600 illustrates example procedures used by various embodiments. Flow diagram 600 includes some procedures that, in various embodiments, are carried out by one or more processors under the control of computer-readable and computer-executable instructions. In this fashion, procedures described herein and in conjunction with flow diagram 600 are, or may be, implemented in an automated fashion using a computer, in various embodiments. The computer-readable and computer-executable instructions can reside in any tangible, non-transitory computer-readable storage media, such as, for example, in data storage features such as peripheral computer-readable storage media 502, RAM 508, ROM 510, and/or storage device 512 (all illustrated in FIG. 5) or the like. Some non-limiting examples of tangible computer-readable storage media include random access memory, read only memory, magnetic disks, and optical disks. The computer-readable and computer-executable instructions, which reside on tangible, non-transitory computer-readable storage media, are used to control or operate in conjunction with, for example, one or some combination of processor(s) 506 (see e.g., FIG. 5), or other similar processor(s). It is appreciated that the processor(s) may be physical or virtual or some combination (it should also be appreciated that a virtual processor is implemented on physical hardware).

Although specific procedures are disclosed in flow diagram 600, such procedures are examples. That is, embodiments are well suited to performing various other procedures or variations of the procedures recited in flow diagram 600. Likewise, in some embodiments, the procedures in flow diagram 600 may be performed in an order different than presented and/or not all of the procedures described may be performed. It is further appreciated that procedures described in flow diagram 600 may be implemented in hardware, or a combination of hardware with firmware and/or software.

FIGS. 6A-6D illustrate a flow diagram of an example method of adding a surrogate as a digital proxy to user data associated with a user and sharing the user data by the surrogate, in accordance with various embodiments. Various components of system 100 are utilized in the performance of the described procedures in the flow diagrams of FIGS. 6A-6D.

With reference to 602 of FIG. 6A, in some embodiments at an authentication server 130, in response to a user 103 accessing the authentication server 130 via a user interface 105 of an application (e.g., a healthcare application), the user 103 is authenticated to achieve an authenticated user.

With reference to 604 of FIG. 6A, in some embodiments at an authentication server 130, in response to a receiving a surrogate add request via the user interface 105 from the authenticated user 103, generating a single-use temporary link 215 to the authentication server 130.

With reference to 606 of FIG. 6A, in some embodiments, in response to the authentication server 130 being accessed via the single-use temporary link 215 a plurality of actions may be performed, with examples given by procedures 608-612.

With reference to 608 of FIG. 6A, in some embodiments, system 100 verifies, such as via information provided to authentication server 130 via login user interface 120, an identity of the surrogate 203 who used the temporary link 215.

With reference to 610 of FIG. 6A, in some embodiments, system 100 confirms, such as via a confirmation user interface 140A, that the surrogate 203 approves acting as a digital proxy for the user 103.

With reference to 612 of FIG. 6A, in some embodiments, system 100 reconfirms, such as via confirmation user interface 140B, with the user 103 that it is still desired for the surrogate 203 to act as a digital proxy for the user 103.

With reference to 614 of FIG. 6A, in some embodiments, authentication server 130 of system 100, in response to the surrogate 203 being verified in identity, confirmed to approve acting a digital proxy for the user 103, and reconfirmed by the user 103 to act as a digital proxy, adds the surrogate 203 as digital proxy authorized to access and share the user data associated with the user 103.

In various embodiments, the third-party application which provides user interface 105 may be one of a healthcare application, a financial application, an insurance application, a legal/judicial information application (such as one provided by a court system), and/or an application specific to and associated with a system for surrogate authentication and data sharing (e.g., system 100).

In some embodiments, procedures in FIG. 6B may be performed separately from or in conjunction with (e.g., as a continuation of) procedures illustrated in FIG. 6A.

With reference to 616 of FIG. 6B, in some embodiments, system 100 receives user data 155 from the user 103 after authentication of the user 103 by the authentication server 130.

With reference to 618 of FIG. 6B, in some embodiments, system 100 uses a private key 491 to store the user data 155 in an encrypted state in an encrypted datastore 150. The private key 491 is shared with the authentication server 130 and is associated with the user 103.

With reference to 620 of FIG. 6B, in some embodiments, system 100 in response to the surrogate 203 accessing the authentication server 130, being authenticated by the authentication server 130, and providing a valid data claim 110 from a third-party application (e.g., application UI 105 which is running as part of the third-party application, the authentication server 130 generates a single-use datastore token 102. The single-use datastore token 102 may include various aspects some of which are described in procedures 622-626. In some embodiments, SUDT 102 includes one or more instructions, many examples of which have been described herein.

With reference to 622 of FIG. 6B, in some embodiments, the SUDT 102 identifies an encrypted datastore 150 from a plurality of encrypted datastores, where the identified encrypted datastore is the location of the user data reverenced by the data claim 110.

With reference to 624 of FIG. 6B, in some embodiments, the SUDT 102 provides instructions for decrypting the encrypted user data associated that is with the data claim 110 and stored the encrypted datastore 150 to achieve decrypted user data 155, wherein the decrypted user data 155 is the same as the user data 155 received from the user 103. That is, the user provides the user data, it is encrypted, and after it is decrypted it is the same as the data originally provided.

With reference to 626 of FIG. 6B, in some embodiments, the SUDT 102 provides direction to the encrypted datastore 150 for how and/or where forward the decrypted user data 155 to the third-party application (e.g., it may send it to one or more of applications associated with UIs 105A, 105B, 105C, or the devices 104A, 104B, 104C associated with them).

In some embodiments, procedures in FIG. 6C may be performed separately from or in conjunction with (e.g., as a continuation of) procedures illustrated in FIG. 6A and/or 6B. For example, in some embodiments, procedure 628 of FIG. 6C is performed after procedure 626 of FIG. 6B.

With reference to 628 of FIG. 6C, in some embodiments, the encrypted datastore 150 employs the decryption instructions of the single-use datastore token 102 to decrypt encrypted user data associated with the data claim 110 and stored in the encrypted datastore 150 to achieve the decrypted user data 155.

With reference to 630 of FIG. 6C, in some embodiments, the encrypted datastore 150 sends the decrypted user data 155 to the third-party application(s) in accordance to the direction of the instructions provided by the single-use datastore token 102 for how and/or where to forward decrypted user data 155. It should be appreciated, that in some embodiments encrypted datastore 150 is in a location that is physically remote from any other components of system 100.

In some embodiments, procedures in FIG. 6D may be performed separately from or in conjunction with (e.g., as a continuation of) procedures illustrated in FIG. 6A, 6B, and/or 6C. For example, in some embodiments, procedure 640 of FIG. 6D is performed after procedure 630 of FIG. 6C.

With reference to 640 of FIG. 6D, in some embodiments, in response to the surrogate 203 of the user 103 accessing the authentication server 130, being authenticated by the authentication server 130, and providing a second valid data claim 110 from a second third-party application (e.g., from user interface 105B which runs as part of a second third-party application), authentication server 130 generates a second single-use datastore token. The second single-use datastore token 102 may include various aspects some of which are described in procedures 642-646.

With reference to 642 of FIG. 6D, in some embodiments, the second SUDT 102 identifies an encrypted datastore 150 from a plurality of encrypted datastores, where the identified encrypted datastore is the location of the user data reverenced by the second data claim 110.

With reference to 644 of FIG. 6D, in some embodiments, the second SUDT 102 provides instructions for decrypting the second encrypted user data associated with the second valid data claim 110 and stored the encrypted datastore 150 to achieve second decrypted user data 155.

With reference to 646 of FIG. 6D, in some embodiments, the second SUDT 102 provides direction to the encrypted datastore 150 for how and/or where forward the second decrypted user data 155 to the second third-party application (e.g., it may send it to one or more of applications associated with UIs 105A, 105B, 105C, or the devices 104A, 104B, 104C associated with them).

With reference to 648 of FIG. 6D, in some embodiments, the encrypted datastore 150 employs the second decryption instructions of the second single-use datastore token 102 to decrypt the second encrypted user data that is stored in the encrypted datastore 150 to achieve the second decrypted user data 155.

With reference to 650 of FIG. 6D, in some embodiments, the encrypted datastore 150 sends the second decrypted user data to the second third-party application (e.g., an application that UI 105B is a part of) according to the direction of the second single-use datastore token 102 for how and/or where to forward the second decrypted user data 155.

In various embodiments, the second third-party application which provides user interface 105B may be one of a healthcare application (which is the same as or different than the health care application described in conjunction with FIG. 6A), a financial application, an insurance application, and a legal information application (such as one provided by a court system).

In various embodiments, the single-use datastore tokens described herein include the necessary private key for decryption of encrypted user data or encrypted second user data which is stored in the encrypted datastore 150. In various embodiments, the encrypted user data and/or the encrypted second user data that is described herein may be one of PHI, other health data, financial data, insurance data, legal data, or other sensitive or personal user data.

### Succinct Descriptions of Various Aspects

In a first aspect, a method of adding a surrogate as a digital proxy to user data associated with a user is performed. The method comprises actions performed at or by various components of a surrogate authentication and data sharing system. At an authentication server of the system, in response to a user accessing the authentication server via a user interface, the user is authenticated based on provided credentials to achieve an authenticated user. In response to a receiving a surrogate add request, via a user interface, from the authenticated user, generating a single-use temporary link to the authentication server. The single-use temporary link is then provided to a person who has been designated by the user to act as their surrogate for PHI or other sensitive or personal user data. In response to the authentication server being accessed via the single-use temporary link, the authentication server: verifies an identity of the surrogate who used the link; confirms that the surrogate approves acting as a digital proxy for the user; and reconfirms with the user that it is still desired for the surrogate to act as a digital proxy for the user. In response to the surrogate being: verified in identity, confirmed to approve acting a digital proxy for the user, and reconfirmed by the user to act as a digital proxy, the authentication server adds the surrogate to the authentication server as digital proxy who is authorized to access and share user data, associated with the user, which is stored in an encrypted datastore. In some instances, this method aspect is implemented as a system. In some instances, this method aspect is implemented as a non-transitory computer-readable medium with instructions embodied thereon which, when executed cause one or more processors to perform procedures of the method.

In a second aspect, a method of sharing data of a user (i.e., “user data”) by a surrogate of the user is performed. The surrogate acts as a digital proxy for the user, with authorization to request/receive personal or sensitive data (i.e., user data) that is typically restricted only to purview of the user. The method comprises actions performed by various components of a surrogate authentication and data sharing system. At an authentication server of the surrogate authentication and data sharing system, receiving user data from a user who has been authenticated by the authentication server is received. The received user data is stored in an encrypted datastore with a private key. The private key is shared with the authentication server and associated with the user. In some aspects, the private key is provided by the user or provided by the authentication server. In response to a surrogate of the user, who has been previously added to the authentication server accessing the authentication server, being authenticated by the authentication server, and providing a valid data claim from a third-party application the authentication server generates a single-use datastore token. The single-use datastore token: identifies the encrypted datastore from a plurality of encrypted datastores; provides instructions for decrypting encrypted user data associated with the valid data claim and stored in the encrypted datastore to achieve decrypted user data, wherein the decrypted user data is the same as the user data received from the user; and provides direction to the encrypted datastore for how to forward the decrypted user data to the third-party application. The encrypted datastore employs the decryption instructions of the single-use datastore token to decrypt the encrypted user data stored in the encrypted datastore to achieve the decrypted user data. In some aspects, the single-use datastore token includes a private key as part of the decryption instructions. The encrypted datastore sends the decrypted user data to the third-party application according to the direction/instructions, provided by the single-use datastore token, for how and where to forward the decrypted user data. In some instances, this method aspect is implemented as a non-transitory computer-readable medium with instructions embodied thereon which, when executed cause one or more processors to perform procedures of the method.

In some instances of the second aspect, in response to the surrogate of the user accessing the authentication server; the surrogate being authenticated by the authentication server; and the surrogate providing a valid data claim from a second third-party application, the second aspect further comprises: generating, by the authentication server, a second single-use datastore token, wherein the second single-use datastore token: identifies the encrypted datastore from a plurality of encrypted datastores; provides instructions for decrypting encrypted user data associated with the valid data claim and stored in the encrypted datastore to achieve the decrypted user data; and provides direction to the encrypted datastore for how to forward the decrypted user data to the second third-party application. The encrypted datastore employs the decryption instructions of the second single-use datastore token to decrypt user data from the encrypted datastore to achieve the decrypted user data (in accordance with data requested in a data claim). The encrypted datastore sends the decrypted user data to the second third-party application according to the direction/instructions provided by the second single-use datastore token for how and/or where to forward decrypted user data. In some instances, the third-party application is a healthcare application. In some instances, the second third-party application is a second healthcare application which may be either the same or different from the other healthcare application. In some instances, the second third-party application is a financial services application. In some instances, the second third-party application is an insurance application.

In a third aspect, a method of adding a surrogate as a digital proxy to user data associated with a user and sharing the user data by the surrogate is performed. The method comprises actions performed at or by various components of a surrogate authentication and data sharing system. At an authentication server of the system, in response to a user accessing the authentication server via a user interface, the user is authenticated based on provided credentials to achieve an authenticated user. In response to a receiving a surrogate add request, via a user interface, from the authenticated user, generating a single-use temporary link to the authentication server. The single-use temporary link is then provided to a person who has been designated by the user to act as their surrogate for PHI or other sensitive or personal user data. In response to the authentication server being accessed via the single-use temporary link, the authentication server: verifies an identity of the surrogate who used the link; confirms that the surrogate approves acting as a digital proxy for the user; and reconfirms with the user that it is still desired for the surrogate to act as a digital proxy for the user. In response to the surrogate being: verified in identity, confirmed to approve acting a digital proxy for the user, and reconfirmed by the user to act as a digital proxy, the authentication server adds the surrogate to the authentication server as digital proxy who is authorized to access and share user data, associated with the user, which is stored in an encrypted datastore. Once confirmed and reconfirmed, the surrogate acts as a digital proxy for the user, with authorization to request/receive personal or sensitive user data (such as PHI) that is typically restricted only to purview of the user. At an authentication server of the surrogate authentication and data sharing system, user data from a user who has been authenticated by the authentication server is received. The received user data is stored in an encrypted datastore with a private key. The private key is shared with the authentication server and associated with the user. In some aspects the private key is provided by the user or provided by the authentication server. In response to a surrogate of the user, who has been previously added to the authentication server accessing the authentication server, being authenticated by the authentication server, and providing a valid data claim from a third-party application the authentication server generates a single-use datastore token. The single-use datastore token: identifies the encrypted datastore from a plurality of encrypted datastores; provides instructions for decrypting encrypted user data associated with the valid data claim and stored in the encrypted datastore to achieve decrypted user data, wherein the decrypted user data is the same as the user data received from the user; and provides direction to the encrypted datastore for how to forward the decrypted user data to the third-party application. The encrypted datastore, employs the decryption instructions of the single-use datastore token to decrypt the encrypted user data stored in the encrypted datastore to achieve the decrypted user data. In some aspects the single-use datastore token includes a private key as part of the decryption instructions. The encrypted datastore sends the decrypted user data to the third-party application according to the direction, provided by the single-use datastore token, for how and where to forward the decrypted user data. In some instances, this method aspect is implemented as a non-transitory computer-readable medium with instructions embodied thereon which, when executed cause one or more processors to perform procedures of the method.

In some instances of the third aspect, in response to the surrogate of the user accessing the authentication server, the surrogate being authenticated by the authentication server, and the surrogate providing a second valid data claim from a second third-party application, the second aspect further comprises: generating, by the authentication server, a second single-use datastore token, wherein the second single-use datastore token: identifies the encrypted datastore from a plurality of encrypted datastores; provides instructions for decrypting second encrypted user data associated with the second valid data claim and stored in the encrypted datastore to achieve the second decrypted user data; and provides direction to the encrypted datastore for how to forward the second decrypted user data to the second third-party application. The encrypted datastore employs the decryption instructions of the second single-use datastore token to decrypt second user data from the encrypted datastore to achieve the decrypted user data (in accordance with data requested in the second valid data claim). The encrypted datastore sends the second decrypted user data to the second third-party application according to the direction of the second single-use datastore token for how and where to forward the second decrypted user data. In some instances, the third-party application is a healthcare application. In some instances, the second third-party application is a second healthcare application which may be either the same or different from the other healthcare application. In some instances, the second third-party application is a financial services application. In some instances, the second third-party application is an insurance application.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A system for adding a surrogate as a digital proxy to user data associated with a user and sharing the user data by the surrogate, the system comprising:
an authentication server comprising memory, storage, and a processor and configured to:
responsive to a user accessing the authentication server via a user interface, authenticate the user to achieve an authenticated user;
responsive to a receiving a surrogate add request via the user interface from the authenticated user, generate a single-use temporary link to the authentication server;
responsive to the authentication server being accessed via the single-use temporary link:
verify an identity of the surrogate;
confirm that the surrogate approves acting as a digital proxy for the user; and
reconfirm with the user that it is still desired for the surrogate to act as a digital proxy for the user;
responsive to the surrogate being verified in identity, confirmed to approve acting a digital proxy for the user, and reconfirmed by the user to act as a digital proxy, add the surrogate to the authentication server as digital proxy authorized to access and the share user data associated with the user;
receive user data from the user after authentication of the user by the authentication server;
use a private key to store the user data in an encrypted state in an encrypted datastore, wherein the private key is shared with the authentication server and associated with the user; and
responsive to the surrogate accessing the authentication server, being authenticated by the authentication server, and providing a valid data claim from a third-party application, generate, by the authentication server, a single-use datastore token, wherein the single-use datastore token:
identifies the encrypted datastore from a plurality of encrypted datastores;
provides instructions for decrypting encrypted user data associated with the valid data claim and stored in the encrypted datastore to achieve decrypted user data, wherein the decrypted user data is the same as the user data received from the user; and
provides direction to the encrypted datastore for how to forward the decrypted user data to the third-party application; and
a data storage server comprising memory, storage, and a processor and configured to:
employ, by the encrypted datastore located on the data storage server, the decryption instructions of the single-use datastore token to decrypt encrypted user data associated with the data claim and stored in the encrypted datastore to achieve the decrypted user data; and
send, by the encrypted datastore located on the data storage server, the decrypted user data to the third-party application according to the direction of the single-use datastore token for how and where to forward decrypted user data.

2. The system of claim 1, further comprising:
responsive to the surrogate of the user accessing the authentication server, being authenticated by the authentication server, and providing a second valid data claim from a second third-party application, the authentication server being further configured to generate a second single-use datastore token, wherein the second single-use datastore token:
identifies the encrypted datastore from a plurality of encrypted datastores;
provides instructions for decrypting second encrypted user data associated with the second valid data claim and stored in the encrypted datastore to achieve second decrypted user data; and
provides direction to the encrypted datastore for how to forward the second decrypted user data to the second third-party application;
the encrypted datastore being configured to employ the decryption instructions of the second single-use datastore token to decrypt second encrypted user data associated with the second valid data claim and stored in the encrypted datastore to achieve the second decrypted user data; and
send the second decrypted user data to the second third-party application according to the direction of the second single-use datastore token for how and where to forward second decrypted user data.

3. The system of claim 1, wherein the third-party application is a healthcare application.

4. The system of claim 2, wherein the second third-party application is a healthcare application.

5. The system of claim 4, wherein the second third-party application is a second healthcare application which is different from the healthcare application.

6. The system of claim 2, wherein the second third-party application is an insurance application.

7. The system of claim 2, wherein the second third-party application is a financial services application.

8. The system of claim 1, wherein the single-use datastore token includes the private key provided for decryption of encrypted user data in the encrypted datastore.

9. The system of claim 1, wherein the decrypted user data comprises personal health information of the user.

10. A method of adding a surrogate as a digital proxy to user data associated with a user and sharing the user data by the surrogate, the method comprising:
at an authentication server:
responsive to a user accessing the authentication server via a user interface, authenticating the user to achieve an authenticated user;
responsive to a receiving a surrogate add request via the user interface from the authenticated user, generating a single-use temporary link to the authentication server;
responsive to the authentication server being accessed via the single-use temporary link:
verifying an identity of the surrogate;
confirming that the surrogate approves acting as a digital proxy for the user; and
reconfirming with the user that it is still desired for the surrogate to act as a digital proxy for the user;
responsive to the surrogate being verified in identity, confirmed to approve acting a digital proxy for the user, and reconfirmed by the user to act as a digital proxy, adding the surrogate to the authentication server as digital proxy authorized to access and share the user data associated with the user;
receiving the user data from the user after authentication of the user by the authentication server;
using a private key to store the user data in an encrypted state in an encrypted datastore, wherein the private key is shared with the authentication server and associated with the user; and
responsive to the surrogate accessing the authentication server, being authenticated by the authentication server, and providing a valid data claim from a third-party application generating, by the authentication server, a single-use datastore token, wherein the single-use datastore token:
identifies the encrypted datastore from a plurality of encrypted datastores;
provides instructions for decrypting encrypted user data associated with the valid data claim and stored in the encrypted datastore to achieve decrypted user data, wherein the decrypted user data is the same as the user data received from the user; and
provides direction to the encrypted datastore for how to forward the decrypted user data to the third-party application;
at a data storage server:
employing, by the encrypted datastore, the decryption instructions of the single-use datastore token to decrypt encrypted user data associated with the valid data claim and stored in the encrypted datastore to achieve the decrypted user data; and
sending, by the encrypted datastore, the decrypted user data to the third-party application according to the direction of the single-use datastore token for how to forward decrypted user data.

11. The method as recited in claim 10, further comprising:
responsive to the surrogate of the user accessing the authentication server, being authenticated by the authentication server, and providing a second valid data claim from a second third-party application, generating, by the authentication server, a second single-use datastore token, wherein the second single-use datastore token:
identifies the encrypted datastore from a plurality of encrypted datastores;
provides instructions for decrypting second encrypted user data associated with the second valid data claim and stored in the encrypted datastore to achieve second decrypted user data; and
provides direction to the encrypted datastore for how and where to forward the second decrypted user data to the second third-party application;
employing, by the encrypted datastore, the second decryption instructions of the second single-use datastore token to decrypt the second encrypted user data stored in the encrypted datastore to achieve the second decrypted user data; and
sending, by the encrypted datastore, the second decrypted user data to the second third-party application according to the direction of the second single-use datastore token for how and where to forward the second decrypted user data.

12. The method as recited in claim 10, wherein the third-party application is a healthcare application.

13. The method as recited in claim 11, wherein the second third-party application is a healthcare application.

14. The method as recited in claim 13, wherein the second third-party application is a second healthcare application which is different from the healthcare application.

15. The method as recited in claim 11, wherein the second third-party application is an insurance application.

16. The method as recited in claim 11, wherein the second third-party application is a financial services application.

17. The method as recited in claim 10, wherein the single-use datastore token includes the private key for decryption of encrypted user data in the encrypted datastore.

18. The method as recited in claim 10, wherein the decrypted user data comprises personal health information of the user.

19. A non-transitory computer-readable storage medium comprising instructions embodied thereon which, when executed by one or more processors cause the one or more processors to perform a method of adding a surrogate as a digital proxy to user data associated with a user and sharing the user data by the surrogate, the method comprising:
at an authentication server:
responsive to a user accessing the authentication server via a user interface, authenticating the user to achieve an authenticated user;
responsive to a receiving a surrogate add request via the user interface from the authenticated user, generating a single-use temporary link to the authentication server;
responsive to the authentication server being accessed via the single-use temporary link:
verifying an identity of the surrogate;
confirming that the surrogate approves acting as a digital proxy for the user; and
reconfirming with the user that it is still desired for the surrogate to act as a digital proxy for the user;
responsive to the surrogate being verified in identity, confirmed to approve acting a digital proxy for the user, and reconfirmed by the user to act as a digital proxy, adding the surrogate to the authentication server as digital proxy authorized to access and share the user data associated with the user;
receiving the user data from the user after authentication of the user by the authentication server;
using a private key to store the user data in an encrypted state in an encrypted datastore, wherein the private key is shared with the authentication server and associated with the user; and
responsive to the surrogate accessing the authentication server, being authenticated by the authentication server, and providing a valid data claim from a third-party application, generating, by the authentication server, a single-use datastore token, wherein the single-use datastore token:
identifies the encrypted datastore from a plurality of encrypted datastores;
provides instructions for decrypting encrypted user data associated with the valid data claim and stored in the encrypted datastore to achieve decrypted user data, wherein the decrypted user data is the same as the user data received from the user; and
provides direction to the encrypted datastore for how to forward the decrypted user data to the third-party application;
at a data storage server:
employing, by the encrypted datastore, the decryption instructions of the single-use datastore token to decrypt encrypted user data associated with the valid data claim and stored in the encrypted datastore to achieve the decrypted user data; and
sending, by the encrypted datastore, the decrypted user data to the third-party application according to the direction of the single-use datastore token for how to forward decrypted user data.

20. The non-transitory computer-readable storage medium of claim 19, wherein the method further comprises:
responsive to the surrogate of the user accessing the authentication server, being authenticated by the authentication server, and providing a second valid data claim from a second third-party application, generating, by the authentication server, a second single-use datastore token, wherein the second single-use datastore token:
identifies the encrypted datastore from a plurality of encrypted datastores;
provides instructions for decrypting second encrypted user data associated with the second valid data claim and stored in the encrypted datastore to achieve second decrypted user data; and
provides direction to the encrypted datastore for how and where to forward the second decrypted user data to the second third-party application;
employing, by the encrypted datastore, the second decryption instructions of the second single-use datastore token to decrypt the second encrypted user data stored in the encrypted datastore to achieve the second decrypted user data; and
sending, by the encrypted datastore, the second decrypted user data to the second third-party application according to the direction of the second single-use datastore token for how and where to forward the second decrypted user data.
